(19) United States
(12) Patent Application Publication
(10) Pub. No.: US 2025/0374391 A1
(43) Pub. Date: Dec. 4, 2025

(54) COOKING APPLIANCE

(71) Applicant: LG Electronics Inc., Seoul (KR)

(72) Inventors: Dong Hun KIM, Seoul (KR); Seong Wook MIN, Seoul (KR); Hyun Seung KIM, Seoul (KR); Young Jin KIM, Seoul (KR); Jeongkil KIM, Seoul (KR); Junhwan JANG, Seoul (KR); Hansu LEE, Seoul (KR)

(73) Assignee: LG Electronics Inc., Seoul (KR)

(21) Appl. No.: 19/212,044

(22) Filed: May 19, 2025

(30) Foreign Application Priority Data
May 30, 2024 (KR) 10-2024-0070856
Dec. 16, 2024 (KR) 10-2024-0187156
Dec. 16, 2024 (KR) 10-2024-0187157

(51) Int. Cl. H05B 6/64; H05B 6/70; H05B 6/72

(52) U.S. Cl. CPC H05B 6/6441; H05B 6/6414; H05B 6/702; H05B 6/72

(57) ABSTRACT

A cooking appliance including a main body with a cavity defined therein, and a door that opens and closes the cavity. The main body includes a microcomputer. The microcomputer controls operations of various components installed in the main body. Also a door including a display board that is electrically connected to a display and controls an operation of the display, a control board electrically connected to the display board and including a controller that controls the operation of the display, and a first communication board electrically connected to the control board and connecting a cooking appliance with another home appliance so as to enable communication therewith.

### CROSS-REFERENCE TO RELATED APPLICATION

This application claims priority to and benefit of Korean Patent Application No. 10-2024-0070856, filed on May 30, 2024, Korean Patent Application No. 10-2024-0187156, filed on Dec. 16, 2024, and Korean Patent Application No. 10-2024-0187157, filed on Dec. 16, 2024, all of which are hereby expressly incorporated by reference as if fully set forth herein.

### BACKGROUND

### Field

The present disclosure relates to a cooking appliance, and more particularly, to a cooking appliance installed above a heating cooking apparatus.

### Description of Related Art

Content described in this section merely provides background information on the present disclosure and does not constitute the prior art.

A cooking appliance is a home appliance that cooks food using a microwave, which is a type of an electromagnetic wave, and/or heater heat. The cooking appliance may be generally composed of a cavity, which is a space in which the food is placed and cooked, and a door that opens and closes the cavity.

When the cooking appliance is installed indoors, it is necessary to consider efficient use of the cooking appliance, saving of an installation space, and the like.

For this reason, the cooking appliance may be disposed at a location adjacent to a heating cooking appliance, for example, a heating oven, a gas stove, and the like. Specifically, the cooking appliance may be disposed above the heating cooking apparatus.

When the cooking appliance is disposed above the heating cooking apparatus, a user may conveniently cook the food by reducing a movement in an environment in which the cooking appliance and the heating cooking apparatus are adjacent to each other. In addition, heat, oil vapor, and the like generated from the heating cooking apparatus may be discharged to the outside using the cooking apparatus as a hood.

For example, a display may be mounted on a front surface of the door equipped in the cooking appliance to provide various information to the user. The user may identify a cooked state of the food via the display.

In addition, when the display is connected to another home appliance to serve as a hub of the home appliance, information other than the cooking of the food may be obtained via the display. In addition, a command necessary for the cooking and various other commands may be input to the display by a touch method.

### SUMMARY

A purpose of the present disclosure is to provide a cooking appliance having a structure of being in direct communication with at least one other home appliance and controlling an operation thereof.

Further, a purpose of the present disclosure is to provide a cooking appliance having a structure that is connected to a user's terminal and a server so as to enable communication with them.

Further, a purpose of the present disclosure is to provide a cooking appliance having a structure that may suppress occurrence of electrical noise in a communication cable that connects various electrical devices to each other.

Further, a purpose of the present disclosure is to provide a cooking appliance equipped with a bead for suppressing occurrence of electrical noise and a cable.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

An embodiment of a cooking appliance may include a main body with a cavity defined therein, and a door that opens and closes the cavity. A microcomputer may be disposed in the main body. The microcomputer may control operations of various components installed in the main body.

An embodiment of the door may include a display board that is electrically connected to a display and controls an operation of the display.

The door may include a control board that is electrically connected to the display board and has a controller that controls the operation of the display.

The door may include a first communication board that is electrically connected to the control board and connects the cooking appliance with another home appliance so as to enable communication therewith.

The door may include a display board that is electrically connected to the display and controls the operation of the display, and a control board that is electrically connected to the display board and has a controller that controls the operation of the display.

The door may include a display board that is electrically connected to the display and controls the operation of the display, and a first communication board connecting the cooking appliance with another home appliance so as to enable communication therewith.

The door may include a control board electrically connected to the display board and having a controller that controls the operation of the display, and a first communication board electrically connected to the control board and connecting the cooking appliance with another home appliance so as to enable communication therewith.

The control board may be connected to a plurality of other home appliances so as to enable communication therewith via the first communication board.

The control board may receive an operation command for another home appliance from a user input via the display, and may control an operation of said another home appliance by transmitting the operation command to said another home appliance via the first communication board.

The door may include an antenna electrically connected to the control board and connecting at least one of a server and a terminal with the cooking appliance so as to enable communication therewith.

The control board may receive the operation command or update information transmitted from a server or a terminal via the antenna to operate the cooking appliance or update an operation program of the cooking appliance.

The cooking appliance may be connected to the server and the user's terminal so as to enable communication therewith using the antenna. Accordingly, the cooking appliance may smoothly receive update information regarding a control program from the server.

Another embodiment of a door may include a plurality of boards. The door may include a cable electrically connecting the plurality of boards to each other. The door may include a bead disposed on the cable.

The bead may eliminate or suppress electrical noise occurring in the cable because of high data transmission capacity and high-speed data transmission.

The door may include a first cable electrically connecting a display board with a control board. The door may include a first bead disposed on the first cable and including a ferrite material.

The door may include the display board that is electrically connected to a display and controls an operation of the display, the control board electrically connected to the display board and having a controller that controls the operation of the display, the first cable electrically connecting the display board with the control board, and the first bead disposed on the first cable and including a ferrite material.

The first bead may eliminate or suppress electrical noise occurring in the first cable because of high data transmission capacity and high-speed data transmission.

The door may include a second cable electrically connecting the control board with the first communication board. The door may include a second bead disposed on the second cable and including the ferrite material.

The door may include the second cable electrically connecting the control board with the first communication board, and the second bead disposed on the second cable and including the ferrite material.

The second bead may eliminate or suppress electrical noise occurring in the second cable because of high data transmission capacity and high-speed data transmission.

Each of the first cable and the second cable may include a plurality of wires. At least one of the first cable and the second cable may include a shield member that is disposed to surround the plurality of wires and is made of a metal material.

Noise occurring in an electricity line may be blocked from being radiated to the outside by the shield member surrounding the electricity line.

In the cooking appliance according to the present disclosure, the control board may be connected to the plurality of other home appliances so as to enable communication therewith via the first communication board. Accordingly, the cooking appliance may control operations of other home appliances connected to the cooking appliance so as to enable communication therewith.

Accordingly, the user may easily control other home appliances by inputting the commands to the display of the cooking appliance, thereby easily using the cooking appliance and other home appliances.

In addition, in the cooking appliance according to the present disclosure, the cooking appliance may be connected to the server and the user's terminal so as to enable communication therewith. Accordingly, the cooking appliance may smoothly receive the update information regarding the control program from the server. In addition, the user may easily control the cooking appliance from the remote location using the terminal and thus enjoy convenience.

In addition, in the cooking appliance according to the present disclosure, the first bead may eliminate or suppress the electrical noise occurring in the first cable.

Accordingly, the communication line disposed in the first cable may avoid the electrical noise occurring because of the electricity line, and effectively suppress the occurrence of the failure resulted from the noise in the display connected to the first cable.

In addition, in the cooking appliance according to the present disclosure, the second bead may eliminate or suppress the electrical noise occurring in the second cable.

Accordingly, the communication line disposed in the second cable may avoid the electrical noise occurring because of the electricity line, and effectively suppress the occurrence of the failure resulted from the noise in the first communication board connected to the second cable.

In addition, in the cooking appliance according to the present disclosure, the noise resulted from the high data transmission capacity and the high-speed data transmission may occur in the first cable and the second cable, and the first bead and the second bead may effectively eliminate or suppress such noise.

In addition, in the cooking appliance according to the present disclosure, the noise occurring in the electricity line may be blocked from being radiated to the outside by the shield member surrounding the electricity line, and therefore, the board adjacent to the first cable and the second cable may be free from the influence of the noise occurring in the electricity line, so that the operating performance of the electric device disposed in the cooking appliance may be improved.

In addition to the above-described effects, specific effects of the present disclosure will be described together while describing specific matters for implementing the present disclosure.

### BRIEF DESCRIPTION OF DRA WINGS

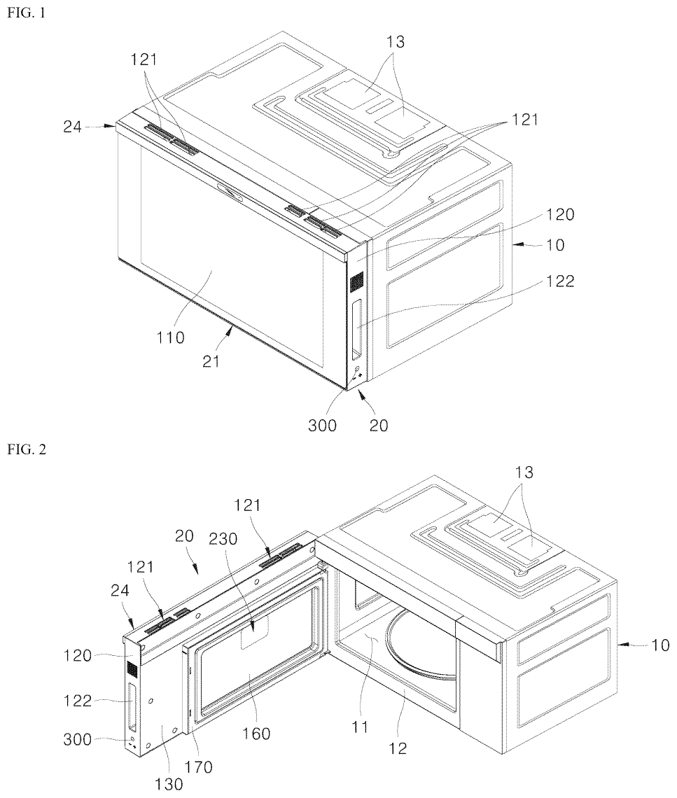

FIG. 1 is a perspective view illustrating a cooking appliance according to an embodiment.

FIG. 2 is a view illustrating a state in which a door is opened in FIG. 1.

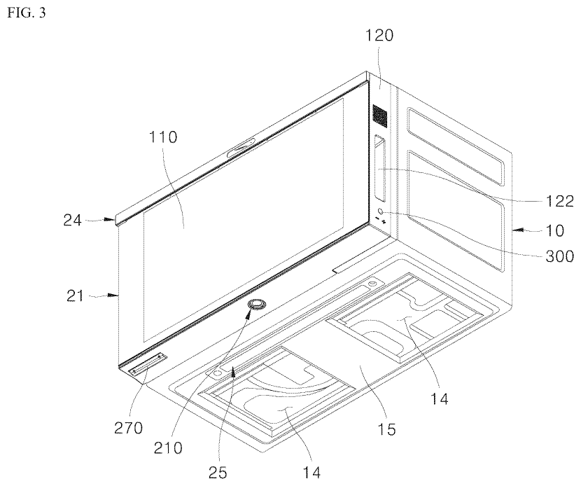

FIG. 3 is a view of FIG. 1 in another direction.

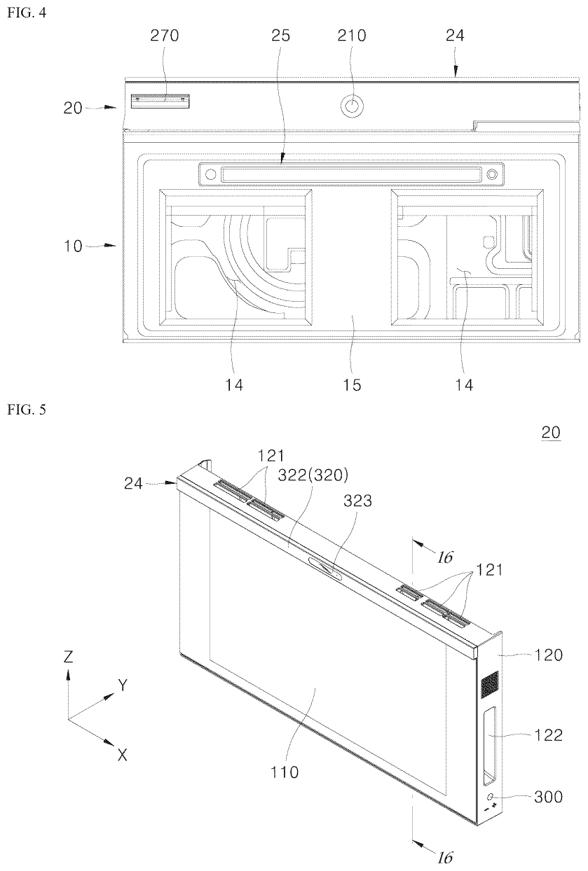

FIG. 4 is a bottom view of a cooking appliance according to an embodiment.

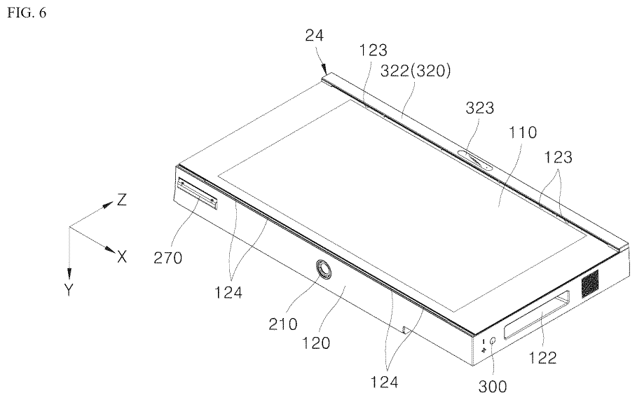

FIG. 5 is a perspective view illustrating a door of a cooking appliance according to an embodiment.

FIG. 6 is a view of FIG. 5 in another direction.

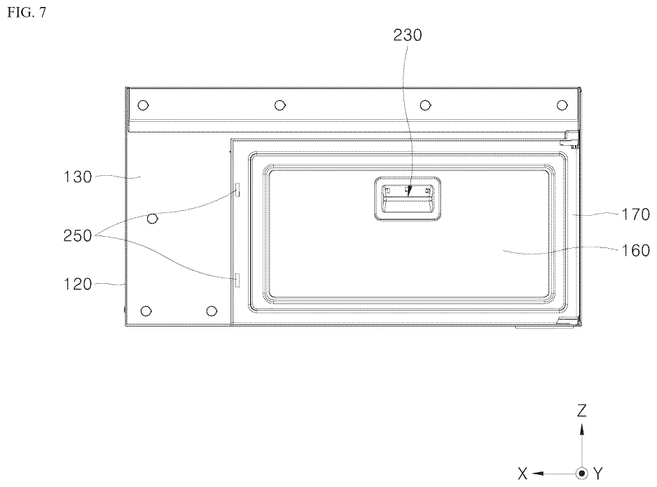

FIG. 7 is a rear view of a door.

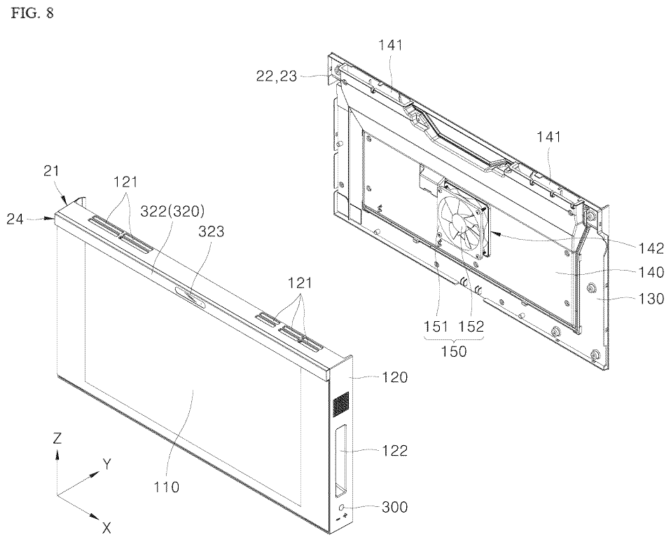

FIG. 8 is an exploded perspective view of a portion of a door according to an embodiment.

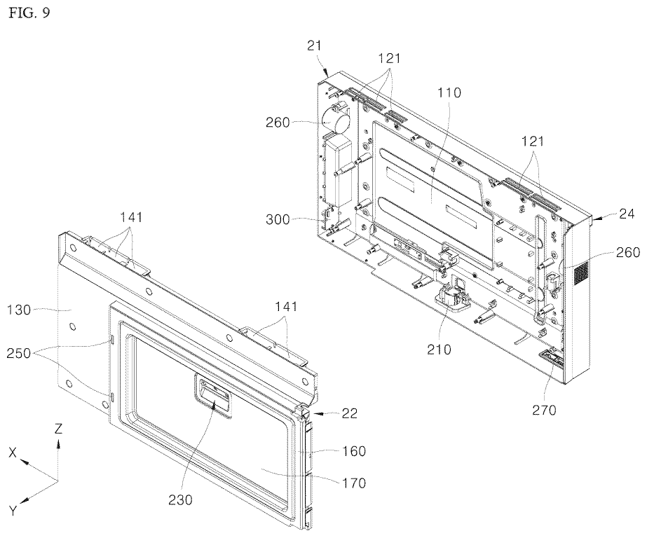

FIG. 9 is a view of FIG. 8 in another direction.

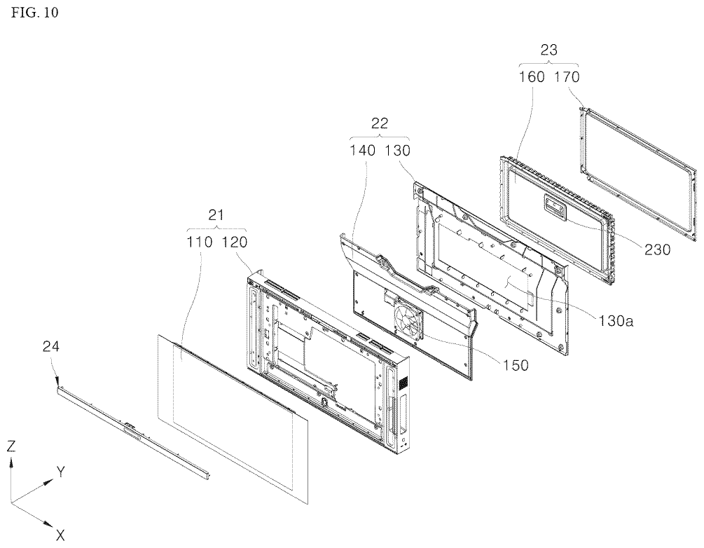

FIG. 10 is an exploded perspective view of a door according to an embodiment.

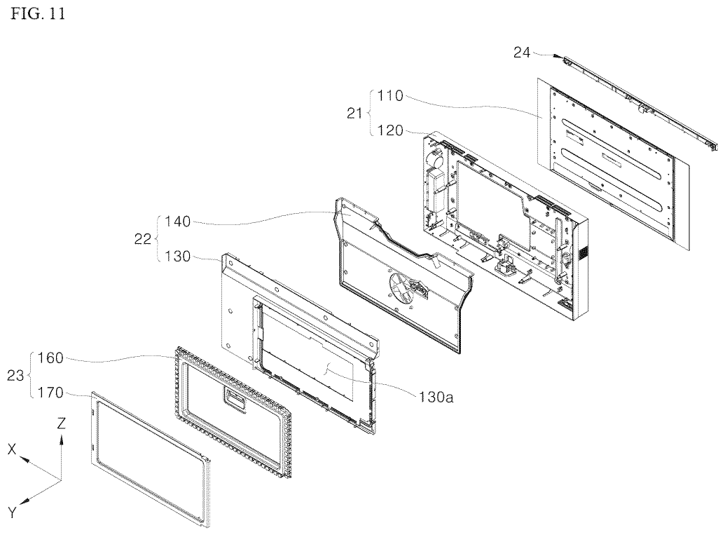

FIG. 11 is a view of FIG. 10 in another direction.

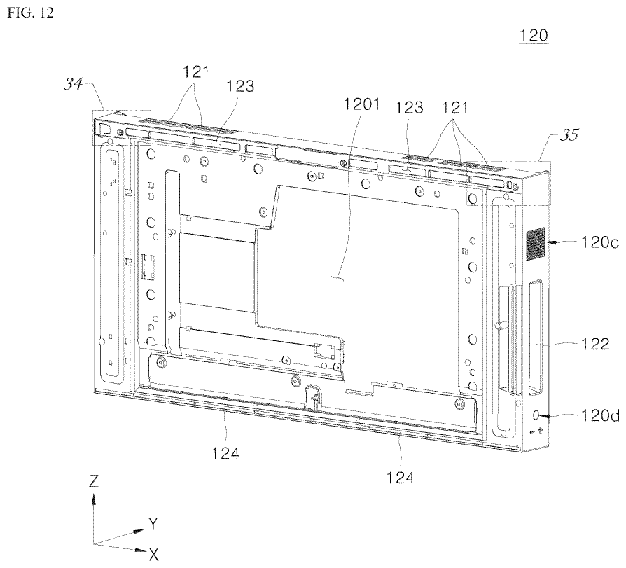

FIG. 12 is a perspective view illustrating an outer panel according to an embodiment.

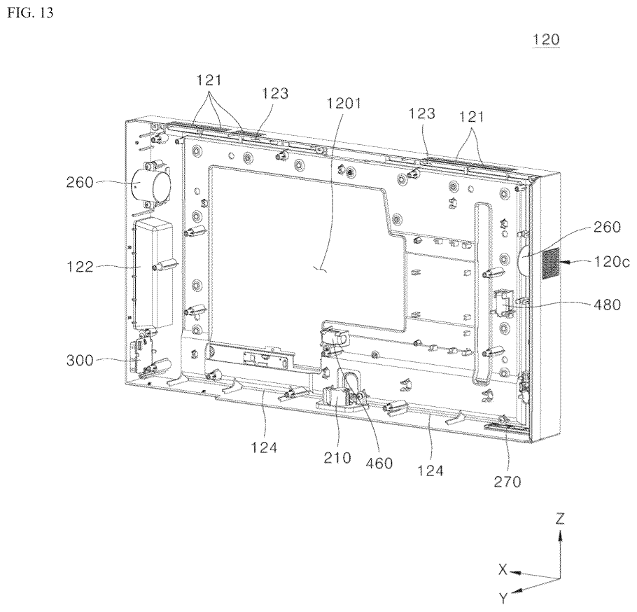

FIG. 13 is a view of FIG. 12 in another direction.

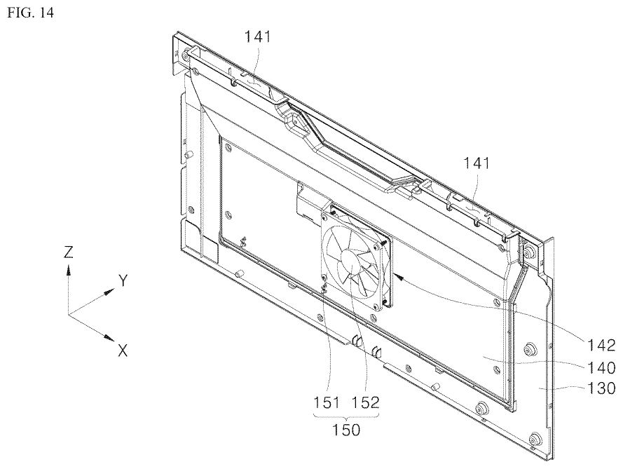

FIG. 14 is a view illustrating an inner panel and an air guide according to an embodiment.

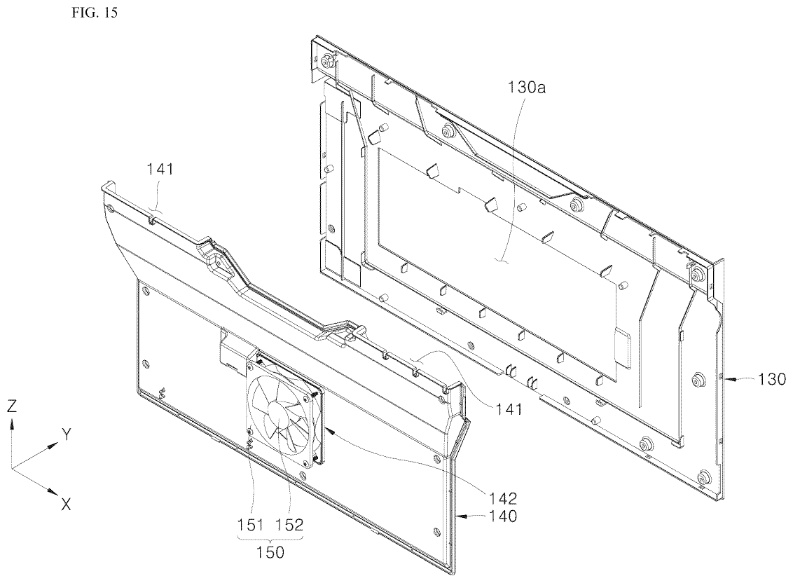

FIG. 15 is an exploded perspective view of FIG. 14.

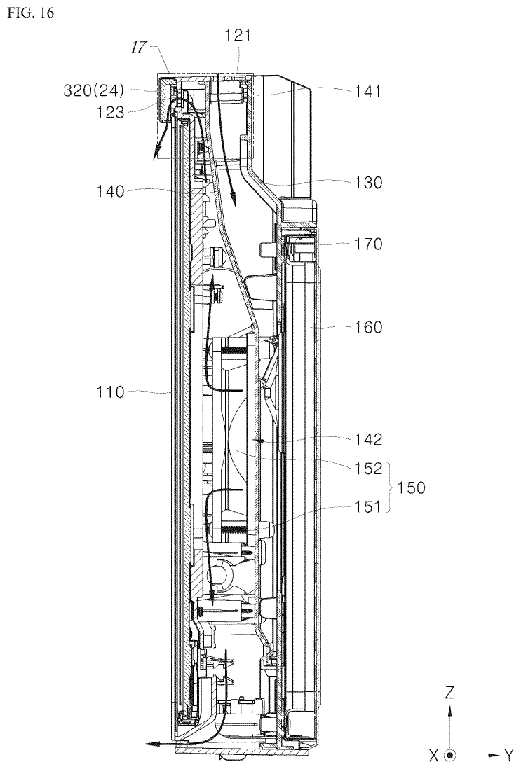

FIG. 16 is a side cross-sectional view of a door viewed in a direction 16-16 in FIG. 5.

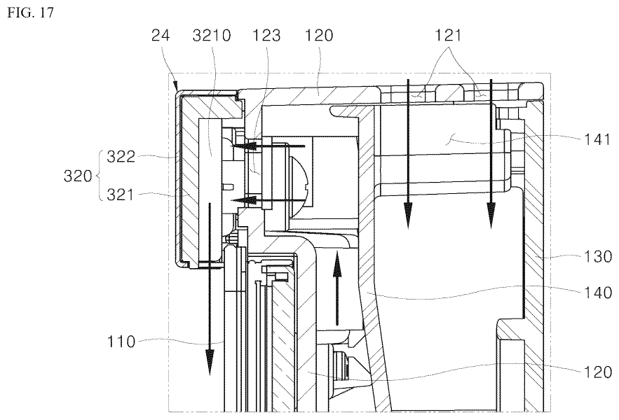

FIG. 17 is an enlarged view of a portion 17 in FIG. 16.

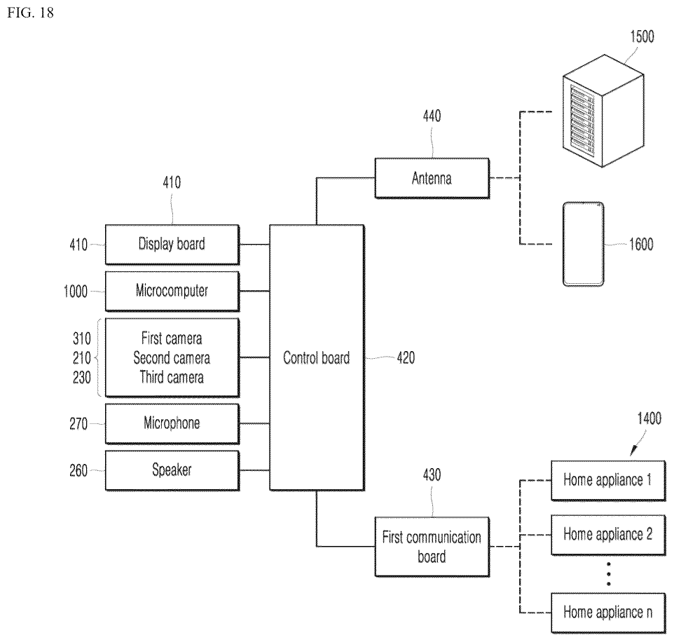

FIG. 18 is a diagram for illustrating control and communication of a cooking appliance according to an embodiment.

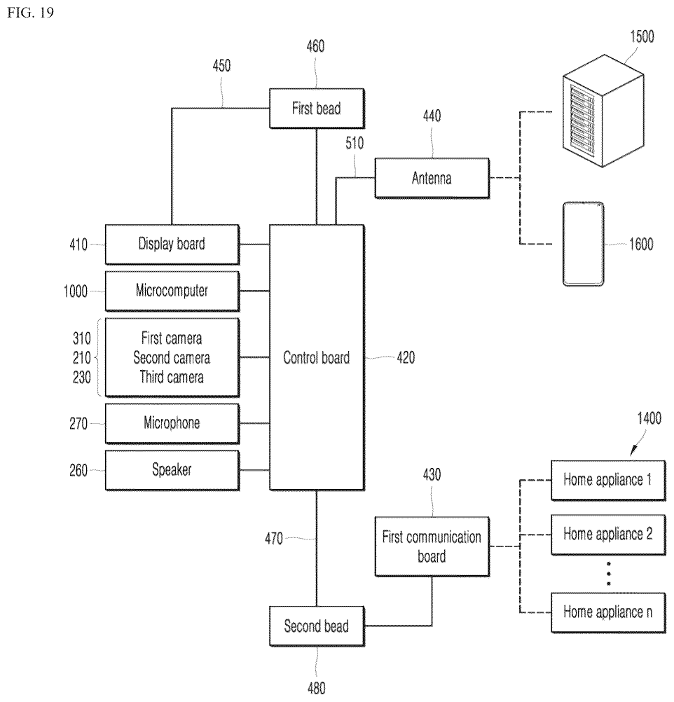

FIG. 19 is a diagram illustrating a structure in FIG. 18 equipped with a bead.

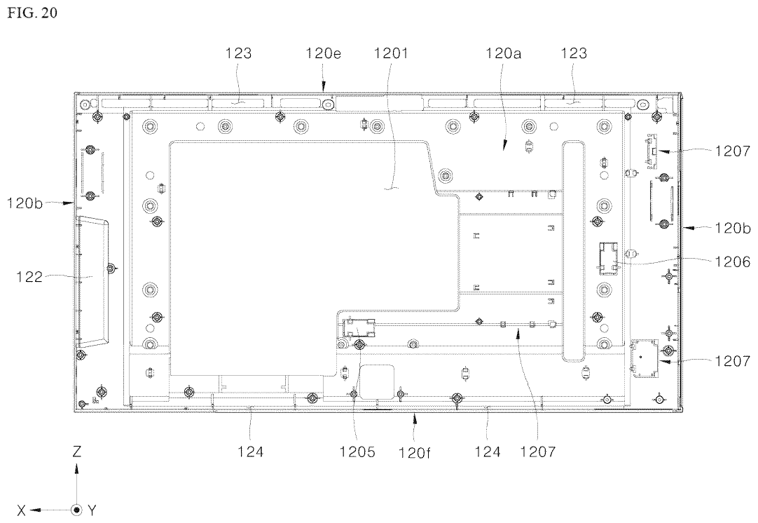

FIG. 20 is a rear view of an outer panel.

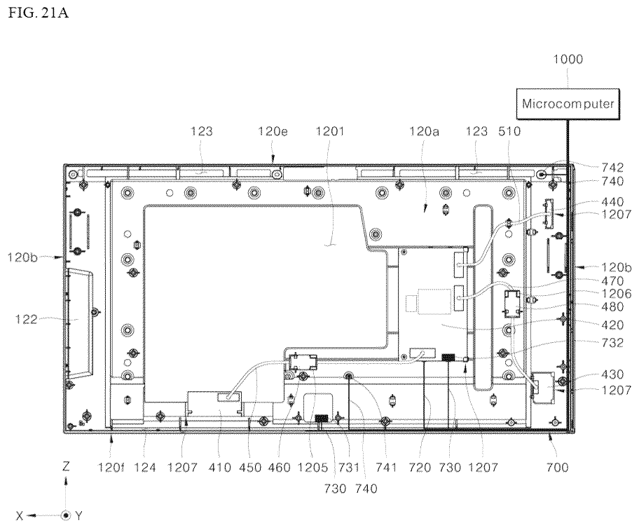

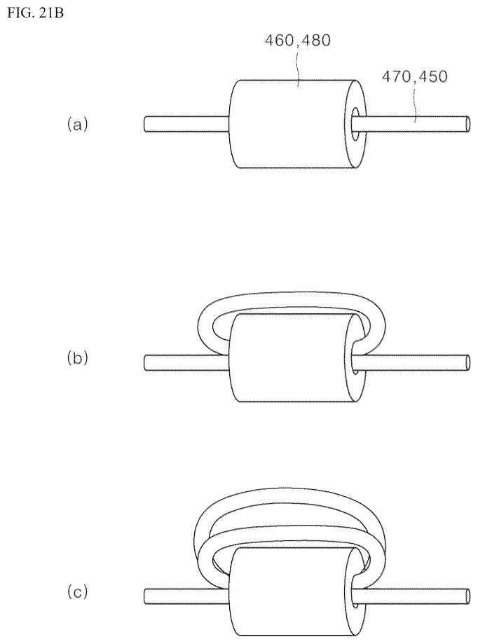

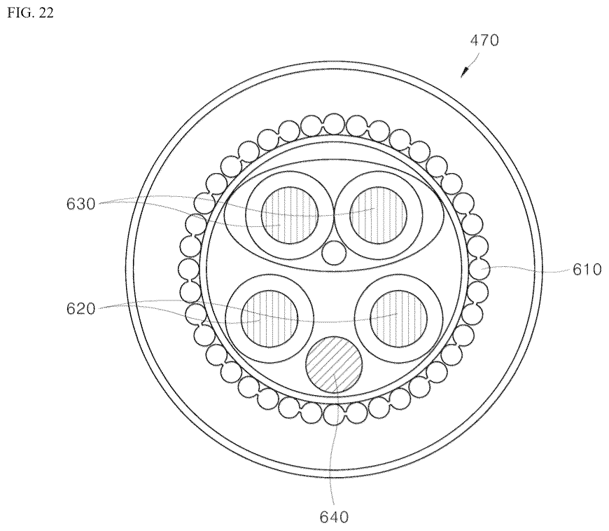

FIG. 21A is a diagram illustrating a state in which a board, a bead, and a cable are disposed on an outer panel.

FIG. 21B is a diagram illustrating a structure in which a bead and a cable are coupled to each other.

FIG. 22 is a diagram illustrating a cross-section of a connecting cable.

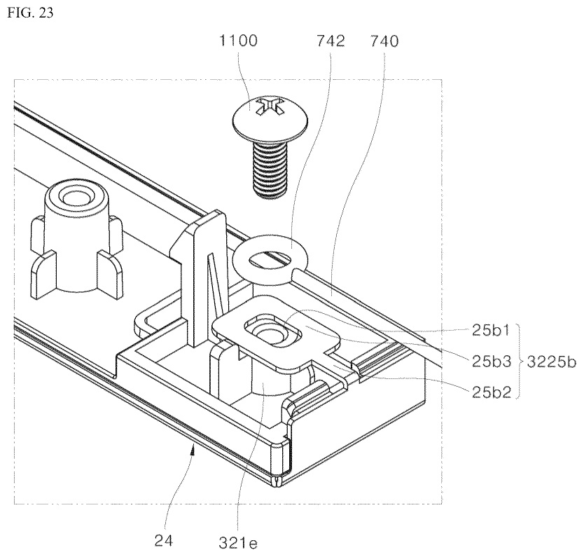

FIG. 23 is a diagram for illustrating a structure in which a second grounding terminal is coupled to a front protruding portion.

### DETAILED DESCRIPTIONS

The above-mentioned purposes, features, and advantages will be described in detail later with reference to the attached drawings, so that those skilled in the art in the technical field to which the present disclosure belongs may easily practice the technical ideas of the present disclosure. In describing the present disclosure, when it is determined that a detailed description of the publicly known technology related to the present disclosure may unnecessarily obscure the gist of the present disclosure, the detailed description thereof will be omitted. Hereinafter, a preferred embodiment according to the present disclosure will be described in detail with reference to the attached drawings. In the drawings, identical reference numerals are used to indicate identical or similar components.

Although first, second, and the like are used to describe various components, these components are not limited by such terms. Such terms are only used to distinguish one component from another component, and unless specifically stated to the contrary, a first component may also be a second component.

Throughout the present document, unless otherwise stated, each component may be singular or plural.

As used herein, singular expressions include plural expressions, unless the context clearly dictates otherwise. In the present application, terms such as “composed of” or “include” should not be construed as necessarily including all of various components or steps described herein, and should be interpreted as being able to not including some of the components or the steps and further including additional components or steps.

Throughout the present disclosure, “A and/or B” means A, B, or A and B, unless otherwise specified, and “C to D” means C inclusive to D inclusive unless otherwise specified.

Throughout the present document, a “vertical direction” refers to a vertical direction of a cooking appliance in a state in which the cooking appliance is installed to be used on a daily basis. A “left and right direction” means a direction orthogonal to the vertical direction, and a front and rear direction means a direction orthogonal to both the vertical direction and the left and right direction. A “lateral direction” has the same meaning as the left and right direction, and such terms are able to be used interchangeably herein.

FIG. 1 is a perspective view illustrating a cooking appliance according to an embodiment. FIG. 2 is a view illustrating a state in which a door 20 is opened in FIG. 1.

The cooking appliance according to an embodiment may be disposed above a location where a heating cooking appliance, for example, a heating oven, a gas stove, and the like, is disposed, at a location spaced apart from the heating cooking appliance in the vertical direction.

Because of such an arrangement of the cooking appliance, a user may conveniently use cooking apparatuses including the cooking appliance. In addition, the cooking appliance may serve as a hood of the heating cooking apparatus disposed below. In this case, the cooking appliance may include components for the use as the hood.

The cooking appliance may cook food using a microwave, which is a type of an electromagnetic wave, and/or heater heat. The cooking appliance may include a main body 10 in which the cavity 11 is formed, and a door 20 that opens and closes the cavity 11.

The food to be cooked may be placed in the cavity 11. The door 20 may be disposed in front of the cavity 11 and pivotably mounted on the main body 10 to open and close the cavity 11.

The cooking appliance may serve as the hood for discharging gaseous foreign substances discharged from the heating cooking apparatus disposed below to the outside. To this end, a vent hole 13 for discharging moisture, oil vapor, and the like generated in the heating cooking appliance disposed below the cooking appliance to the outside may be defined at an upper portion of the main body 10.

The main body 10 may further include a front panel 12 that is disposed at an edge of an entrance of the cavity 11, and closes the cavity 11 by being disposed such that one surface thereof faces one surface of a choke member 170 when the door 20 is closed.

The front panel 12 may be disposed to surround the entrance edge of the cavity 11 and protrude with a predetermined width. Accordingly, when the door 20 is closed, an edge of the door 20 and the cavity 11 may overlap each other.

Because of such a structure, the front panel 12 may seal the cavity 11 in the state in which the door 20 is closed, thereby suppressing oil, moisture, oil vapor, and the like generated during a cooking process of the food placed in the cavity 11 from being leaked to the outside via the entrance of the cavity 11.

FIG. 3 is a view of FIG. 1 in another direction. FIG. 4 is a bottom view of a cooking appliance according to an embodiment.

A suction unit 14 for sucking moisture, oil vapor, and the like rising from the heating cooking appliance may be disposed at a lower portion of the main body 10. Accordingly, the cooking appliance may serve as the hood that sucks air discharged from the heating cooking appliance disposed below the cooking appliance and discharges the air to the outside.

The suction unit 14 and the vent hole 13 may be defined to be in communication with each other, and thus, gas such as oil vapor introduced into the suction unit 14 may be discharged to the outside via the vent hole 13, and the vent hole 13 may be in communication with a duct connected to the outside.

In one example, the cavity 11 of the cooking appliance is formed not to be in communication with the suction unit 14 and the vent hole 13, so that gas such as oil vapor introduced from the suction unit 14 may be discharged to the outside of the main body 10 directly via the vent hole 13 without being introduced into the cavity 11.

A bottom panel 15 may be disposed at the lower portion of the main body 10, and the suction unit 14 may be formed to extend through the bottom panel 15 and be in communication with the vent hole 13.

The bottom panel 15 may include a lighting unit 25 that irradiates light in a downward direction. Such a lighting unit may be formed, for example, in a shape long in the lateral direction of the cooking appliance. By the light irradiated from the lighting unit 25, the user may conveniently use the heating cooking appliance disposed below the cooking appliance.

FIG. 5 is a perspective view illustrating the door 20 of the cooking appliance according to an embodiment. FIG. 6 is a view of FIG. 5 in another direction.

FIG. 7 is a rear view of the door 20. FIG. 8 is an exploded perspective view of a portion of the door 20 according to an embodiment. FIG. 9 is a view of FIG. 8 in another direction.

The door 20 may include a display module 21, a cooling flow path 22, and a shielding portion 23. The display module 21 may be disposed at a front portion of the door 20, and the user may view inside of the cavity 11 of the cooking appliance through the display module 21.

The cooling flow path 22 may be disposed at the rear of the display module 21, and a flow path through which air for cooling flows may be formed therein. Air introduced into the door 20 may flow inside the door 20 via the cooling flow path 22 to cool the door 20.

The shielding portion 23 may be disposed at the rear of the cooling flow path 22, and may shield the electromagnetic wave generated in the main body 10. The shielding portion 23 may protect the user by blocking the electromagnetic wave generated in the cavity 11 and propagated to the outside of the cooking appliance.

For example, the shielding portion 23 may serve to block the electromagnetic wave (the microwave) generated to cook the food in the main body 10 from being discharged to the outside of the door 20.

The cooling flow path 22 may be disposed to cool electronic components mounted inside the door 20, including a display 110 mounted on the display module 21. In the cooling flow path, air that cools the door 20 may flow inside. The display 110 may be formed in a thin shape and may be disposed such that an area thereof occupies a significant portion of one surface of the door 20.

Accordingly, the display 110 is formed to occupy a significant portion of a front surface area of the door 20, and the area of the display 110 is increased, so that visibility to the user may be improved. The user may conveniently check the various information via the display 110 formed as a large screen.

Because the display 110 is enlarged, an amount of heat generated may increase. Therefore, the display 110 needs to be effectively cooled on the door 20. In an embodiment, the cooling flow path through which cooling air flows may be separately disposed.

The cooling flow path 22 may be disposed at the rear of the display 110, so that cooling air may flow, and thus the display module 20 may be effectively cooled by air flowing through the cooling flow path 22. In addition, heating components mounted in the display module 21 may also be cooled by air flowing through the cooling flow path 22. That is, the cooling flow path 22 may cool the display module 21 equipped with the display 110 and various other heating components.

To effectively cool the display 110, an entirety of the display 110 needs to be exposed to air flowing through the cooling flow path 22. In addition, the air flow passing through the cooling flow path 22 and discharged to the outside of the door 20 needs to form an air curtain to block heat and oil vapor rising from the heating cooking appliance disposed below the cooking appliance.

To this end, air flowing through the cooling flow path 22 may be branched from the inside of the cooling flow path 22 so as to be discharged upward and downward of the display module 21.

As cooling air is branched from the inside of the cooling flow path 22 and discharged upward and downward of the display module 21, cooling air may flow while coming into contact with an entirety of a rear surface of the display 110 to effectively cool the display 110.

In addition, as cooling air is discharged upward and downward of the display module 21, the air curtain is effectively formed around the display and the door 20, so that heat and oil vapor rising from the heating cooking appliance disposed below the cooking appliance may be effectively blocked by the air curtain.

The display module 21 may be equipped with the display 110, a camera, and other electronic components, and the cooling flow path 22 may be equipped with electronic components such as a blower 150 operated by a motor. Accordingly, to protect the user and the electronic components from the electromagnetic wave, the shielding portion 23 that shields the electromagnetic wave generated in the main body may be disposed at the rear of the cooling flow path 22.

In the display module 21, the display 110 and various electronic components may be disposed. Further, the cooling flow path 22 in which a flow path of air that cools the display module 21 is formed may be disposed at the rear of the display module 21, and the shielding portion 23 that shields the electromagnetic wave from reaching the electronic components equipped in the display module 21 may be disposed at the rear of the cooling flow path 22.

In an embodiment, the display module 21 for providing the various information and convenience to the user needs to be disposed on a front surface of the cooking appliance, that is, at a forefront of the door 20. In addition, in an embodiment, a structure is required to effectively cool the components such as the display 110 equipped in the display module 21, to form the flow path of cooling air for forming the air curtain around the door 20 while effectively cooling the inside of the door 20 equipped with the display 110 and the like, and to protect the electronic components mounted in the door 20 from the electromagnetic wave.

To meet such a need, the display module 21 may be disposed at the foremost of the door 20, the cooling flow path 22 may be disposed at the rear of the display module 21, and the shielding portion 23 may be disposed at the rear of the cooling flow path 22.

That is, to implement the door structure according to the above-described embodiment, the display module 21, the cooling flow path 22, and the shielding portion 23, which play respective roles in the door 20, need to be sequentially arranged from a front side to a rear side of the door 20.

The display module 21 may include a first outlet 123 and a second outlet 124. The first outlet 123 may be disposed at an upper portion of the display module 21, and air flowing inside the display module 21 may be discharged to the outside via the first outlet 123.

The second outlet 124 may be disposed at a lower portion of the display module 21, and air flowing inside the display module 21 may be discharged to the outside via the second outlet 124. That is, air flowing inside the door 20 may be discharged to the outside via the first outlet 123 and the second outlet 124 respectively disposed at the upper and lower portions of the door 20, and accordingly, air may flow through the entire inside of the door 20 to effectively cool the entire door 20.

The display module 21 may include the display 110 and an outer panel 120. The display 110 may be disposed on the front surface of the door 20 to display a video or an image.

The display 110 may display information necessary for the cooking and provide the information to the user. In addition, the display 110 may receive a user's command in a touch recognition method.

In one example, the display 110 may be communicatively connected to other home appliances, a camera disposed at a main door, a locking device, and the like. In addition, the display 110 may be communicatively connected to an external device required by the user.

The user may receive information necessary for operation of the home appliance, visit of an outsider, and other life from the display 110, and transmit commands to the home appliance and other devices connected to the display 110 using the display 110.

Accordingly, the door 20 including the display 110 may serve as a kind of an IoT hub that transmits the information regarding the home appliance and other devices necessary for living to the user and transmits user's commands to such devices.

The outer panel 120 may be disposed at the rear of the display 110, and the display 110 may be mounted thereon. The outer panel 120 may generally have a hollow 1201 and may be formed in a shape having a predetermined width in a front and rear direction of the door 20.

The hollow 1201 of the outer panel 120 may be closed by a rear surface of the display 110. Air flowing inside the outer panel 120 may hit the rear surface of the display 110 exposed through the hollow 1201 of the outer panel 120. Accordingly, air flowing inside the outer panel 120 may come into contact with the rear surface of the display 110 and cool the display 110.

In addition, air passing through a blower fan 152 may cool the heating components such as a speaker 260, a microphone 270, a printed circuit board, and the like, which are disposed to be exposed through the hollow 1201 of the outer panel 120.

Because the outer panel 120 has the above-described structure, it may have a built-in space, and various components may be built in the built-in space. A width of the door 20 in the front and rear direction may be determined almost by the outer panel 120.

A first vent hole 121 through which air is introduced may be defined in an upper end of the outer panel 120. A plurality of first vent holes 121 may be defined. Each of the first vent holes 121 may be defined such that a plurality of slit-shaped holes are arranged at a distance. Because of such a structure, the external foreign substances may be somewhat suppressed from being introduced into the door 20 via the first vent hole 121.

A handle 122 may be formed at one side of the outer panel 120 to be used when the user opens and closes the door 20. The handle 122 may be defined, for example, by recessing the side of the outer panel 120.

A button device 300 may be mounted on one side of the outer panel 120, for example, directly below a location where the handle 122 is formed. The user may manipulate the button device 300 to supply electricity to the cooking appliance or cut off the supply of electricity. Detailed manipulation related to the operation of the cooking appliance may be performed by inputting a command to the display 110.

The outer panel 120 may support the various components such as the display 110, the speaker 260, the microphone 270, and the printed circuit board for communication or control, and may include the first vent hole 121 through which external air is introduced, and the first outlet 123 and the second outlet 124 through which air is discharged.

In one example, the door 20 may be equipped with the camera. The image filmed by the camera may be reproduced on the display 110, and the user may view an image of an inside of the cavity 11 or a space under the cooking appliance via the display 110. The camera may include a first camera 310, a second camera 210, and a third camera 230.

The first camera 310 may be disposed at an upper front portion of the display module 21 to film a space ahead of the cooking appliance.

The first camera 310 may film the user in front of the cooking appliance. Accordingly, the first camera 310 may be used for the user to make a video call with another person outside the main door or at another remote place using the display 110. The first camera 310 will be described in detail below.

The second camera 210 may be mounted at a lower portion of the outer panel 120 to film a state of a space under the door 20. Because the second camera 210 is mounted at the lower portion of the outer panel 120 such that a line of sight is directed to the space under the cooking appliance, it may film the heating cooking apparatus disposed below the cooking appliance.

The user may observe the state of the heating cooking appliance and a cooked state of food on the heating cooking appliance by the image filmed by the second camera 210 and reproduced on the display 110.

The third camera 230 may be mounted on the frame 160, may be disposed to face the cavity 11, and may film the cavity 11. That is, a line of sight of the third camera 230 may be directed toward the cavity 11 to film a situation of the cavity 11. The user may observe a situation in which the food is cooked in the cavity 11 via the image filmed by the third camera 230.

The door 20 may include a latch 250 mounted at a side of the frame 160 and formed to partially protrude from the frame 160. The latch 250 may be formed in a structure that is hooked to a groove defined in the front panel 12 of the door 20. The latch 250 may stably maintain the closed state of the door 20.

FIG. 10 is an exploded perspective view of the door 20 according to an embodiment. FIG. 11 is a view of FIG. 10 in another direction. The cooling flow path 22 may include an inner panel 130, an air guide 140, and the blower 150.

The inner panel 130 may be disposed at the rear of the outer panel 120 and may be mounted on the outer panel 120. The air guide 140 to be described later may be mounted on the inner panel 130. The inner panel 130 may define a space in which air sucked into the door 20 flows together with the air guide 140.

The air guide 140 may be mounted on the inner panel 130, and may be coupled to the frame 160 to provide the space in which air introduced into the door 20 flows.

The air guide 140 may be disposed between the outer panel 120 and the inner panel 130, and may be coupled to the inner panel 130. The air guide 140 may guide the flow of air introduced into the door 20 from the outside and define the space in which air may flow.

The blower 150 may be mounted on the air guide 140. The blower 150 may forcibly allow air introduced into the air guide 140 to flow from a rear side to a front side of the air guide 140.

The shielding portion 23 may include the frame 160 and the choke member 170. The frame 160 may be disposed at the rear of the inner panel 130, may be coupled to the inner panel 130, and may have one side pivotably coupled to the main body 10. The door 20 may pivot as the frame 160 pivots to open and close the cavity 11 of the cooking appliance.

The frame 160 may be coupled to the inner panel 130 to form a flow path of air for cooling, and at the same time, may have a shielding structure for preventing the electromagnetic wave leakage, that is, the choke member 170, to form an inner surface of the door 20.

The choke member 170 may be disposed at the rear of the frame 160, may be coupled to the frame 160, and may block external emission of the electromagnetic wave generated from the main body 10. The choke member 170 may be formed in a substantially hollow quadrangular shape and may surround edges of the frame 160.

FIG. 12 is a perspective view illustrating the outer panel 120 according to an embodiment. FIG. 13 is a view of FIG. 12 in another direction. FIG. 14 is a view illustrating an inner panel and an air guide according to an embodiment. FIG. 15 is an exploded perspective view of FIG. 14.

Referring to FIG. 13, the door 20 may include the speaker 260 and the microphone 270. At least one speaker 260 may be mounted at a side of the outer panel 120. The speaker 260 may generate a voice, an alarm sound, and the like necessary for the operation of the cooking appliance. In addition, the speaker 260 may generate a voice, an alarm sound, and the like for the door 20 including the display 110 to function as the IoT hub.

The microphone 270 may be mounted at a lower portion of the outer panel 120 and may receive a user's voice. The user may input a voice command for manipulating the cooking appliance via the microphone 270. In addition, the microphone 270 may play a part of a role for the door 20 to function as the IoT hub.

In one example, a communication unit for communication may be disposed in the door. Because the door 20 functions as the IoT hub, it is appropriate that the communication unit disposed in the door 20 is equipped to perform various types of wired or wireless communication functions.

The outer panel 120 may include a first through-hole 120c and a second through-hole 120d. The first through-hole 120c may be defined at the side of the outer panel 120. The first through-hole 120c may be defined adjacent to a location where the speaker 260 is disposed. The first through-hole 120c may be formed in a mesh shape to allow the speaker 260 to be in communication with the outside and simultaneously to suppress the speaker 260 from being exposed to the outside.

The speaker 260 may be in communication with the outside of the outer panel 120 via the first through-hole 120c, thereby effectively transmitting the alarm and other voices to the user. Because the speaker 260 includes a pair of speakers, the first through-hole 120c may also include a pair of first through-holes defined at locations corresponding to the pair of speakers 260, respectively.

The second through-hole 120d may be defined to extend through the outer panel 120 at a lower portion of one side of the outer panel 120. A portion of the button device 300 mounted inside the outer panel 120 may be exposed to the outside of the outer panel 120 via the second through-hole 120d. The user may manipulate the button device 300 by being in contact with an exposed portion of the outer panel 120.

The outer panel 120 may have the first outlet 123 defined at an upper portion thereof and the second outlet 124 defined at a lower portion thereof. The first outlet 123 may be defined at the upper portion of the outer panel 120, and air flowing inside the door may be discharged to the outside by the blower 150. The second outlet 124 may be defined at the lower portion of the outer panel 120, and air flowing inside the door may be discharged to the outside by the blower 150.

The first outlet 123 may be defined at a location adjacent to an upper end of the display 110, and the second outlet 124 may be defined at a location adjacent to a lower end of the display 110. Accordingly, air forced to flow inside the door 20 by the blower 150 may be discharged to the outside at the locations adjacent to the upper end and the lower end of the display 110 via the first outlet 123 and the second outlet 124.

Air discharged via the first outlet 123 may form the air curtain above the door 20. In addition, air discharged via the second outlet 124 may form the air curtain below the door 20.

The air curtain refers to a means for blocking external air flow from penetrating into the door 20. In an embodiment, a boundary surface or a boundary area where the flow of air discharged from the inside of the door 20 via the first outlet 123 and the second outlet 124 forms a boundary with the external air flow may be referred to as the air curtain.

The air curtains formed by air discharged from the inside of the door 20 via the first outlet 123 and the second outlet 124 may suppress external air from penetrating into the door 20.

Because the heating cooking appliance is disposed below the cooking appliance, heat generated when the heating cooking appliance is used and oil vapor generated from the food being cooked may rise and penetrate the cooking appliance.

Heat transferred from the heating cooking apparatus to the cooking apparatus may damage a component of the door 20 disposed in the cooking apparatus. In particular, the display 110 and a component in which a circuit, a module, or the like related to the operation thereof is embedded may be vulnerable to heat.

In addition, oil vapor delivered from the food being cooked may be adhered to the door 20 disposed in the cooking appliance. Oil vapor may be adhered to a surface of the display 110 and degrade an image quality of the display 110, and may be adhered to a surface of other components mounted on the door 20 to damage such components.

In an embodiment, the air flow discharged to the outside of the door 20 via the first outlet 123 and the second outlet 124 defined in the door 20 may form the air curtains, so that heat and oil vapor rising from the heating cooking appliance disposed below the cooking appliance may be effectively blocked by the air curtains.

Accordingly, the various electronic components including the display 110 disposed on the door 20 may be effectively suppressed from being damaged or degraded in function by heat and oil vapor.

Referring to FIG. 14, the air guide 140 may include an inlet 141 and an exhaust port 142. The inlet 141 may be defined at an upper portion of the air guide 140, may allow external air to be introduced thereinto, and may include at least one inlet.

The inlet 141 may be defined at a location corresponding to the first vent hole 121 defined in the upper portion of the outer panel 120. Accordingly, external air may pass through the first vent hole 121 of the outer panel 120 and be introduced into the door 20 via the inlet 141.

The exhaust port 142 may be formed below the inlet 141 in the air guide 140, and the blower fan 152 may be disposed at a location overlapping the exhaust port 142 in the front and rear direction. The exhaust port 142 may be formed to extend through the air guide 140 in the front and rear direction of the door 20.

Accordingly, air may flow from the upper portion to a lower portion of the air guide 140 via the inlet 141, and may flow again via the exhaust port 142 in a changed direction from a rear space to a front space of the air guide 140.

The blower 150 may include a casing 151 and the blower fan 152. The casing 151 may be disposed in the exhaust port 142, may have a hollow defined therein, and may have the blower fan 152 mounted in the hollow.

The blower fan 152 may be rotatably mounted on the casing 151, and may allow air to flow from the rear space to the front space of the air guide 140. The blower fan 152 may rotate by receiving electricity to allow air to flow inside the door 20.

By the rotation of the blower fan 152, external air may be introduced into the door 20 via the inlet 141 and discharged to the outside of the door 20 via the first outlet 123 and the second outlet 124. The exhaust port 142 of the air guide 140 may be formed at a center of the casing 151 to correspond to a location, an area size, and a shape of the hollow in which the blower fan 152 is disposed.

FIG. 16 is a side cross-sectional view of the door 20 viewed in a direction 16-16 in FIG. 5. Hereinafter, the flow of air inside the door 20 will be described in detail with reference to FIG. 16. In FIG. 16, the flow of air is indicated by arrows.

As the blower fan 152 rotates, external air may flow into the door 20 via the inlet 141 of the air guide 140 and may flow to be discharged to the outside of the door 20 via the first outlet 123 and the second outlet 124.

Air forced to flow by the blower fan 152 may specifically have a flow path as follows.

Air may be introduced into the door 20 from the first vent hole 121 of the outer panel 120 and the inlet 141 defined at a location corresponding thereto. Air introduced into the door 20 may flow in a downward direction of the door 20 and may be introduced into the blower fan 152.

Air may pass through the blower fan 152 in the front and rear direction of the door 20. In this regard, air may pass through the exhaust port 142 of the air guide 140 while passing through the blower fan 152. The flow direction of air in the blower fan 152 may be changed from the vertical direction of the door 20 to the front and rear direction.

Because a front space of the exhaust port 142 is blocked by the display 110, air that has passed through the exhaust port 142 may be branched in the vertical direction in a space ahead of the air guide 140.

A portion of the branched air may flow in the upward direction of the door 20 and may be discharged to the first outlet 123. The other portion of the branched air may flow in the downward direction of the door 20 and be discharged to the second outlet 124.

Air branched from the first outlet 123 and the second outlet 124 may surround the entire door 20. The branched air may particularly surround the front surface of the door 20. Because of such a structure, air discharged from the first outlet 123 and the second outlet 124 forms the air curtains on the door 20, thereby effectively suppressing heat and oil vapor generated from the heating cooking appliance disposed below the cooking appliance from penetrating into the door 20.

In addition, because of the above-described air flow structure inside the door 20, air introduced into the door 20 may flow through the entire inside of the door 20. For example, air may flow in an entire space defined by the rear surface of the display 110 and the outer panel 120.

Accordingly, air flowing inside the door 20 may cool the entire rear surface of the display 110 and effectively cool the components mounted on the outer panel 120 and other portions of the door 20.

In particular, the outer panel 120 may be equipped with components that generate heat, such as the speaker 260, the microphone 271, and the printed circuit board. Such heating components may be arranged over the entire outer panel 120. Therefore, air may effectively cool such heating components while flowing through the entire inside of the outer panel 120.

As shown in FIG. 16, the first vent hole 121 through which air is introduced and the inlet 141 may be in communication with each other. As the blower fan 152 rotates, external air may be introduced into the air guide 140 via the first vent hole 121 and the inlet 141 and flow toward the blower 150 via a space defined by the inner panel 130 and the air guide 140.

Air may flow toward the blower fan 152 of the blower 150 in a space defined by the frame 160. Air may pass through the blower fan 152 and hit the rear surface of the display 110 disposed to face the blower fan 152 to cool the display 110.

Air that has passed through the blower fan 152 may hit the rear surface of the display 110, and then the flow thereof may be branched in the upward and downward directions of the display 110. Air directed to an upper side of the display 110 may be discharged to the outside of the door 20 via the first outlet 123 defined at the upper side of the outer panel 120. Air directed to the lower side of the display 110 may be discharged to the outside of the door 20 via the second outlet 124 defined at the lower side of the outer panel 120.

In an embodiment, air flowing inside the door 20 may cool the entire front surface of the display 110 while being discharged via the first outlet 123. In addition, air flowing inside the door 20 may effectively cool the rear surface of the display 110 and the heating components mounted inside the door 20.

The exhaust port 142 may be formed at a center of the air guide 140. The casing 151 may have the hollow having a location, a size, and a shape corresponding to those of the exhaust port 142, and the blower fan 152 may be disposed in the hollow. The casing 151 may be disposed to be located at a location where the hollow thereof and the exhaust port 142 of the air guide 140 correspond to each other, and may be mounted on one surface of the air guide 140.

A hollow 130a may be defined in the inner panel 130. Because the hollow 130a of the inner panel 130 is closed by the frame 160, air introduced via the inlet 141 may not leak into the hollow 130a of the inner panel 130. Accordingly, the inner panel 130 and the frame 160 may form together an air flow path through which air that cools the inside of the door 20 flows.

FIG. 17 is an enlarged view of a portion 17 in FIG. 16. The door 20 may include a front coupling portion 24 disposed upward of the display 110, protruding forwardly of the door 20, and coupled to the outer panel 120.

The front coupling portion 24 may include a first camera 310 and a panel 320. The first camera 310 may be disposed upward and forward of the display module 21, and may sense an external situation.

The panel 320 may be disposed upward and forward of the display module 21, and may cover the first camera 310. Because the panel 320 covers the first camera 310, the panel 320 may form an outer shape of the front coupling portion 24, and the first camera 310 may be accommodated inside the panel 320.

The panel 320 may be disposed such that a longitudinal direction thereof is directed in the lateral direction of the door 20, and may be formed in an overall long rod shape. The panel 320 may change the flow direction of air discharged from the first outlet 123 to the downward direction.

To this end, the panel 320 may be disposed in front of the first outlet 123. The panel 320 may be disposed to overlap the first outlet 123 in the front and rear direction. Air flowing inside the door 20 may be discharged in the forward direction of the door 20 via the first outlet 123 located at the upper portion of the door 20.

In this regard, the panel 320 may block the first outlet 123 from the front, and air discharged from the first outlet may be blocked by the panel 320 and the flow direction thereof may be changed from the forward direction to the downward direction of the door 20.

In addition, a lower end of the panel 320 may protrude further downward than a lower end of the first outlet 123. Because of such a structure, air discharged from the first outlet 123 may collide with the panel 320 and may be guided by the panel 320, so that the flow path thereof may be changed to the downward direction.

Air discharged in the forward direction from the first outlet 123 may collide with a rear surface of the panel 320 and flow in a changed direction toward an open lower portion between the panel 320 and the first outlet 123. In addition, because the lower end of the panel 320 further protrudes in the downward direction than the lower end of the first outlet 123, air may be guided by the lower end of the panel 320 to flow, and then may continue to flow in the downward direction of the door 20 for a certain period of time after exiting the door 20.

Air forced to flow by the blower fan 152 may be introduced from the inlet 141, flow in the downward direction of the door 20, be introduced into the blower fan 152, pass the blower fan 152 in the front and rear direction of the door 20, and diverge in the vertical direction at a location in front of the air guide 140. Further, a portion of air may flow in the upward direction of the door 20 and be discharged to the first outlet 123, and the rest of air may flow in the downward direction of the door 20 and be discharged to the second outlet 124.

In this regard, air discharged from the first outlet 123 may be guided by the panel 320 to flow downward, and at least a portion thereof may comes into contact with the front surface of the display 110. In addition, at least a portion of air discharged from the second outlet 124 may flow forward of the door 20.

Air discharged from the second outlet 124 may flow forward of the door 20, and thus may serve as the air curtain that blocks oil vapor and other foreign substances rising from the heating cooking appliance below the cooking appliance from being adhered to the front surface of the display 110.

Air discharged from the first outlet 123 may form the air curtain like air discharged from the second outlet 124 to prevent oil vapor or the like from being adhered to the front surface of the display 110.

In addition, air discharged from the first outlet 123 may be changed in the flow direction by the panel 320 and discharged in the downward direction of the door 20, so that at least a portion thereof may come into contact with the front surface of the display 110.

Because of such a structure, air discharged from the first outlet 123 may directly come into contact with the front surface of the display 110 to cool the front surface of the display 110. Therefore, the front surface and the rear surface of the display 110 are both cooled by air, so that cooling efficiency may be significantly improved compared to a case in which only the rear surface of the display 110 is cooled.

FIG. 18 is a diagram for illustrating control and communication of a cooking appliance according to an embodiment. The door 20 may include the display 110, and the display 110 may be disposed at the front portion of the door 20 and may display the image.

The display 110 may display information necessary for the cooking and provide the information to the user. In addition, the display 110 may receive the user's command in the touch recognition method.

In one example, the display 110 may be connected to a home appliance 1400 and a camera, a locking device, and the like installed on the main door so as to enable communication with them. In addition, the display 110 may be connected to an external device required by the user so as to enable communication with the same.

The user may receive information necessary for operation of the home appliance, visit by an outsider, and other daily life from the display 110, and may transmit a command to the home appliance and other devices connected to display 110 using the display 110.

Accordingly, the door 20 including the display 110 may serve as a kind of the IoT hub that transmits the information regarding the home appliance and other devices necessary for the living to the user and transmits the user's commands to such devices.

For the user to control the operation of the home appliance 1400 by inputting the command to the display 110, a plurality of home appliances 1400 need to be connected to the cooking appliance according to an embodiment so as to enable direct communication with the same. This will be described in detail below.

The door 20 may include a plurality of boards. The door 20 may include a cable that electrically connect the plurality of boards to each other.

Alternatively, the door 20 may include a bead disposed on the cable. The door 20 may include at least one of the plurality of boards, the cable, and the bead.

Alternatively, the door 20 may include at least one of a display board 410, a control board 420, and a first communication board 430. In addition, the door 20 may include all of the display board 410, the control board 420, and the first communication board 430. Each board may be equipped with various active and passive elements, circuits, and the like, and may implement a control means for controlling a related device.

The display board 410 may be electrically connected to the display 110 and control the operation of the display 110. The display board 410 may be electrically connected to the display 110 and the control board 420, and may transmit information on the image displayed on the display 110 to the display 110.

In addition, the display board 410 may receive the command input by the user from the display 110 and transmit the same to the control board 420. The display 110 may receive the user's input by the touch input method and transmit such input information to the display board 410.

The control board 420 may be electrically connected to the display board 410 and may include a controller that controls the operation of the display. The control board 420 may be electrically connected to various devices, and may receive information from such devices or transmit various information and commands to such devices.

For example, the control board 420 may be electrically connected to a first camera 310, a second camera 210, a third camera 230, a speaker 260, and a microphone 270, and may receive information from such devices or transmit various information and commands to such devices.

The control board 420 may supply power to the cameras and control them, and may receive images filmed by the cameras and control the images to be displayed on the display 110.

The control board 420 may be electrically connected to a microcomputer 1000 disposed in the main body 10, and may receive information from the microcomputer 1000 or transmit various information and commands to such devices.

The microcomputer 1000 may control overall operations of the cooking appliance. For example, the microcomputer 1000 may control on/off of a fan, a heater, a blower, a microwave generator, and the like disposed in the cooking appliance, and may also control the operation of the display 110 via the control board 420.

The microcomputer 1000 may receive a user's input signal from the control board 420 and control the operation of the cooking appliance. In addition, the microcomputer 1000 may transmit a signal regarding a result of the operation control of the cooking appliance to the control board 420.

The control board 420 may transmit the user's input signal to the microcomputer 1000, and also control the display 110 to display the signal received from the microcomputer 1000.

In addition, the control board 420 may be electrically connected to the first communication board 430, may establish communication with the plurality of home appliances 1400 via the first communication board 430, and may establish communication with a server 1500 or a user's terminal 1600 via an antenna 440.

The first communication board 430 may be electrically connected to the control board 420, and may connect the cooking appliance and the home appliance 1400 to each other to establish communication with each other. The first communication board 430 may be connected to enable communication with the home appliance 1400. In this regard, the first communication board 430 may be in communication with the home appliance 1400 in a wireless communication manner, for example.

The first communication board 430 may connect the control board 420 of the cooking appliance and the plurality of home appliances 1400 to each other so as to establish communication with each other, so that the control board 420 may control operations of the plurality of home appliances 1400 selectively or simultaneously. Therefore, because of the first communication board 430, the cooking appliance equipped with the control board 420 may act as a hub for the plurality of home appliances 1400.

In this regard, the home appliance 1400 may be equipped as, for example, a refrigerator, a washing machine, a television, a personal computer, a dishwasher, a robot cleaner, the door locking device of the main door, and the like. Therefore, the user may conveniently use the home appliance 1400 by inputting the command to the cooking appliance.

The control board 420 needs to control the plurality of home appliances 1400 simultaneously. Therefore, the control board 420 needs to be connected to the plurality of home appliances 1400 so as to enable communication with them simultaneously.

When the control board 420 is connected to only one home appliance at a time, it may be inconvenience for the user because the user should perform a communication establish task with each home appliance whenever the user uses a specific home appliance.

Therefore, in an embodiment, the first communication board 430 may connect the control board 420 to the plurality of home appliances 1400 so as to establish communication with them simultaneously. To this end, the first communication board 430 needs to be implemented such that it may establish communication with the plurality of home appliances 1400 simultaneously, and also such that it does not confuse a specific home appliance, for example, a home appliance 1, with a home appliance 3 when being in communication with each home appliance.

To this end, the first communication board 430 may connect the control board 420 and the home appliance 1400 to each other so as to establish communication with each other using a thread communication protocol.

The thread communication protocol may wirelessly connect the plurality of devices to each other, and the plurality of devices may be connected to each other so as to establish communication with each other and may implement a mesh network that forms a single network cluster as a whole.

Therefore, when the cooking appliance and the plurality of home appliances 1400 are connected to each other with the thread communication protocol, they may form a single network cluster and be in communication with each other.

Because of such a structure, the cooking appliance may be in communication with the plurality of home appliances 1400 simultaneously or selectively, and may clearly separate the home appliances 1400 from each other in the communication and may not experience confusion.

In an embodiment, the control board 420 may be connected to the plurality of home appliances 1400 so as to establish communication with them via the first communication board 430. Accordingly, the cooking appliance may control the operations of the home appliances 1400 that are connected thereto so as to establish communication with the same.

Accordingly, the user may easily control the home appliance 1400 by inputting the command to the display 110 of the cooking appliance, thereby easily using the cooking appliance and the home appliance 1400.

The door 20 may include an antenna 440 that is electrically connected to the control board 420 and connects at least one of the server 1500 and the terminal 1600 to the cooking appliance so as to establish communication with the same.

The control board 420 may include a communication module using WiFi or the like, and the communication module may be in communication with the server 1500 or the terminal 1600 via the antenna 440.

The cooking appliance may need to be connected to the server 1500 so as to establish communication with the same to receive program update information or other necessary information from the server 1500 and transmit necessary information to the server 1500. Accordingly, the cooking appliance needs to be connected to the server 1500 so as to establish communication with the same.

In addition, the user needs to remotely control the cooking appliance using the terminal 1600 that the user owns. Accordingly, the cooking appliance needs to be connected to the user's terminal 1600 so as to enable communication with the same. Because of such a structure, the user may control the operation of the cooking appliance from a remote location using the terminal 1600.

In an embodiment, the door 20 may be equipped with the antenna 440, and the control board 420 may be connected to the server 1500 or the user's terminal 1600 so as to enable communication with the same via the antenna 440.

The antenna 440 may connect the home appliance to the server 1500 or the terminal 1600 so as to enable communication with the same in a Wi-Fi manner, for example. The Wi-Fi, as a general-purpose wireless communication means, may easily connect the cooking appliance to the Internet.

Therefore, in an embodiment, the server 1500 and the terminal 1600, which require use of the Internet, may be connected to the cooking appliance so as to establish communication with the same by means of Wi-Fi.

The user's terminal 1600 may also be connected to the first communication board 430 so as to establish direct communication with the same.

In another embodiment, the terminal 1600 may be connected to the server 1500 so as to establish communication with the same, and the server 1500 may be connected to the first communication board 430 so as to establish communication with the same. In this case, the user may control the operation of the cooking appliance using the terminal 1600 even from a very remote location.

The control board 420 may receive an operation command from the user for the home appliance 1400 input via the display 110. In addition, the control board 420 may control the operation of the home appliance 1400 by transmitting the operation command to the home appliance 1400 via the first communication board 430.

That is, the first communication board 430 may connect the control board 420 and the home appliances 1400 to each other so as to establish direct communication with each other, and unlike the antenna 440, the first communication board 430 may not receive a control command from the user or may not be used for communication with the server 1500.

The control board 420 may receive the operation command or the update information transmitted from the server 1500 or the terminal 1600 via the antenna 440, and operate the cooking appliance or update an operation program of the cooking appliance.

That is, the antenna 440 may connect the control board 420 with the server 1500 or the user's terminal 1600 so as to enable communication with the cooking appliance, and unlike first communication board 430, may not connect the server 1500 with the plurality of home appliances 1400. Therefore, the communication via the antenna 440 may not be implemented in the thread communication protocol manner.

In an embodiment, the cooking appliance may be connected to the server 1500 and the user's terminal 1600 so as to enable communication with them using the antenna 440. Accordingly, the cooking appliance may smoothly receive update information regarding a control program from the server 1500. In addition, the user may easily control the cooking appliance from the remote location using the terminal 1600 and thus enjoy convenience.

FIG. 19 is a diagram illustrating a structure in FIG. 18 equipped with a bead. The door 20 may include at least one of a first cable 450 and a first bead 460. In addition, the door 20 may include both the first cable 450 and the first bead 460.

The first cable 450 may electrically connect the display board 410 with the control board 420. The first cable 450 may include a communication line that connects the display board 410 with the control board 420 so as to enable communication with the same. Additionally, the first cable 450 may include an electricity line that supplies electricity to the display board 410.

First, the beads described as the first bead 460 and a second bead 480 in an embodiment will be described. The bead may be formed with an inner member made of a ferrite material and an outer member covering the ferrite. The outer member may be made of, for example, a plastic material.

The bead may remove or suppress electrical noise occurring in the cable. The cables in an embodiment, that is, the first cable 450, may include the communication line, and a second cable 470 may include the electricity line and the communication line.

Unlike a small electronic device such as a smartphone, the cooking appliance in an embodiment is large, so that a length of the cable for electrical connection between parts increases, and thus, noise is likely to occur because of such long cable.

In an embodiment, the display 110 disposed at the front portion of the door 20 may be formed, and the plurality of boards may be disposed at the rear of the display 110. Because a gap between the boards is great, a length of the cable connecting them to each other increases, which may cause noise in the cable.

In one example, the cooking appliance in an embodiment may be equipped with a microwave device to enable cooking using the microwave, and the microwave emitted from such a device may also cause the noise in the cable.

Because the first cable 450 transmits data for the display, it is sensitive to the noise because of a great amount of data transmitted. In other words, even when a small amount of data is lost because of the noise in the first cable 450, a failure may occur in the display 110, so that it is necessary to eliminate or reduce the noise to prevent such a problem.

Because the second cable 470 transmits data at a high speed to the plurality of other home appliances 1400, it is sensitive to the noise. For example, the second cable 470 may be sensitive to the length thereof and the microwave emitted from the cooking appliance, and thus, the noise may occur. To prevent this, it is necessary to eliminate or reduce the noise.

Such noise may cause a failure in the communication line equipped in the cable. Because of the noise, the failure, such as the image not being displayed momentarily on the display 110 or the display screen suddenly turning off, may occur.

Because the noise deteriorates an operating performance of the display 110, it is necessary to eliminate or suppress the same. To this end, the bead including the ferrite material may be disposed to surround the cable.

Ferrite included in the bead may increase an inductance component of the electricity line of the cable, and because of the high inductance, a high-frequency signal significantly higher than an average frequency may be eliminated or suppressed in the electricity line. Accordingly, the noise may be eliminated or occurrence thereof may be suppressed in the cable.

In an embodiment, the bead may be formed integrally with the cable, or may be detachable from the cable. The bead is electrically separated from a wire disposed inside the cable, and therefore, the bead does not become the electricity line or the communication line.

The first bead 460 may be disposed on the first cable 450 and may include the ferrite material. As described above, the first bead 460 may remove or suppress the electrical noise.

Accordingly, the first bead 460 may eliminate or suppress the electrical noise occurring in the first cable 450.

Accordingly, a communication line 620 disposed in the first cable 450 may avoid electrical noise occurring because of an electricity line 630, and may suppress the occurrence of the aforementioned failure resulted from the noise in the display 110 connected to the first cable 450.

The door 20 may include at least one of the second cable 470 and a second bead 480. In addition, the door 20 may include both the second cable 470 and the second bead 480. The second cable 470 may electrically connect the control board 420 with the first communication board 430. The second cable 470 may include the electricity line that supplies the electricity to the first communication board 430 and the communication line that connects the first communication board 430 with the control board 420 so as to enable communication with the same.

The second bead 480 may be disposed on the second cable 470 and may include the ferrite material. As described above, the second bead 480 may remove or suppress the electrical noise.

Therefore, the second bead 480 may be equipped to eliminate or suppress the electrical noise occurring in the second cable 470.

Accordingly, the communication line 620 disposed in the second cable 470 may avoid electrical noise occurring because of the electricity line 630, and may suppress the occurrence of the aforementioned failure resulted from the noise in the first communication board 430 connected to the second cable 470.

The door 20 may include a third cable 510 that electrically connects the control board 420 with the antenna 440. Because a relatively small amount of power is transmitted through the third cable 510, the electrical noise may be relatively low.

Therefore, the third cable 510 may not be equipped with the bead for suppressing the electrical noise. However, when necessary, the bead may also be equipped on the third cable 510 to suppress the occurrence of the failure caused by the noise in the antenna 440.

FIG. 20 is a rear view of the outer panel 120. FIG. 21A is a diagram illustrating a state in which the board, the bead, and the cable are disposed on the outer panel 120.

The door 20 may include the outer panel 120 that is disposed at the rear of the display 110 and on which the display 110 is mounted. Because the outer panel 120 may define the internal space, various boards and beads described above may be disposed in the internal space.

That is, the display board 410, the control board 420, the first communication board 430, and the antenna 440 may be mounted on the outer panel 120, and may be disposed in the internal space defined by coupling the display 110 and the outer panel 120 to each other.

By placing the various boards and beads in such an internal space and also placing the cables connecting them to each other together, the door 20 may look simple and stylish overall.

The outer panel 120 may include a front plate 120a, and a side wall 120b, an upper wall 120e, and a lower wall 120f formed by being bent therefrom. The display 110 may be coupled to the front plate 120a. The side wall 120b may be bent rearward from both side edges of the front plate 120a.

The display 110 may be coupled to a front surface of the front plate 120a, and a first mounting portion 1205 and a second mounting portion 1206 on which the beads to be described below are mounted, and a mounting casing 1207 on which the various boards are mounted may be formed on a rear surface of the front plate 120a.

The upper wall 120e may be bent rearward from an upper end of the front plate 120a, and the lower wall 120f may be bent rearward from the upper end of the front plate 120a. Because of the side wall 120b, the upper wall 120e, and the lower wall 120f, an internal space in which the various boards, beads, and cables may be accommodated may be defined in the outer panel 120.

The outer panel 120 may include at least one of the first mounting portion 1205 and the second mounting portion 1206. In addition, the outer panel 120 may include both the first mounting portion 1205 and the second mounting portion 1206. The first bead 460 may be formed to protrude from the front plate 120a, and the first bead 460 may be detachably mounted. The second mounting portion 1206 may be formed to protrude from the front plate 120a and may be disposed to be spaced apart from the first mounting portion 1205, and the second bead 480 may be detachably mounted thereon.

The first mounting portion 1205 and the second mounting portion 1206 may include protruding portions having a hook structure, for example, such that the beads may be detachably mounted thereon. In one example, the first mounting portion 1205 and the second mounting portion 1206 may be formed in various shapes depending on a three-dimensional shape of the bead.

The first bead 460 may be coupled to the first cable 450, and the second bead 480 may be coupled to the second bead 480. Therefore, considering locations where the first cable 450 and the second cable 470 should be disposed, it is necessary to place the first mounting portion 1205 and the second mounting portion 1206 at appropriate locations on the outer panel 120 such that the first cable 450 and the second cable 470 do not become excessively long because of mounting locations of the beads.

The outer panel 120 may include a plurality of mounting casings 1207 formed to protrude from the front plate 120a and on which the display board 410, the control board 420, the first communication board 430, and the antenna 440 are mounted.

The mounting casing 1207 may have appropriate size and shape considering a sizes and a shape of each board. Each board may be coupled to the mounting casing 1207 corresponding thereto by a form-fitting method, a force-fitting method, or by a coupling mechanism such as a screw.

For example, the control board 420, which has the greatest area size, may be coupled to the mounting casing 1207 corresponding thereto by the form-fitting method, and additionally, may be coupled thereto by the coupling mechanism, thereby being stably coupled to the outer panel 120.

The cooking appliance may include a connecting cable 700 that electrically connects the door 20 with the microcomputer 1000. The connecting cable 700 may include a communication cable 720, an electricity cable 730, and a grounding cable 740. The communication cable 720 may connect the control board 420 and the microcomputer 1000 to each other so as to enable communication with each other.

The electricity cable 730 may electrically connect the components of the door 20 with the microcomputer 1000, and supply electricity from the microcomputer 1000 to the door 20. For example, the electricity cable 730 may electrically connect the display 110 with the microcomputer 1000. To this end, a first power terminal 731 connecting the display 110 with the electricity cable 730 may be disposed on the door 20.

In addition, the electricity cable 730 may electrically connect the control board 420 with the microcomputer 1000. To this end, a second power terminal 732 connecting the control board 420 with the microcomputer 1000 may be disposed on the door 20.

The grounding cable 740 may ground the door 20. For example, the grounding cable 740 may electrically connect the display 110 with the microcomputer 1000. To this end, a first grounding terminal 741 that electrically connects a metal plate disposed on the display 110 with the microcomputer 1000 may be disposed on the door 20.

In addition, the grounding cable 740 may electrically connect a front protruding portion 24 with the microcomputer 1000. To this end, a second grounding terminal 742 that electrically connects a metal portion of the front protruding portion 24 with the microcomputer 1000 may be disposed on the door 20.

FIG. 21B is a diagram illustrating a structure in which a bead and a cable are coupled to each other. Here, the bead means the first bead 460 or the second bead 480, and the cable means the first cable 450 or the second cable 470.

For example, as shown in (a) in FIG. 21B, the cable may extend through the bead. In one example, when the cable is wound around the bead, the noise reduction effect may increase. Therefore, as shown in (b) in FIG. 21B, the cable may be wound around the bead once. Further, as shown in (c) in FIG. 21, the cable may be wound around the bead twice or more.

The number of turns of the cable may be appropriately set in consideration of a length of the cable, a size of the bead, an electromagnetic interface (EMI) value of a surrounding area, and the like.

FIG. 22 is a diagram illustrating a cross-section of the second cable 470. As described above, because the second cable 470 includes the electricity line, the electrical noise may occur. Such electrical noise may be suppressed by the second bead 480, but in addition thereto, it is necessary to additionally suppress an electric field, an electromagnetic wave, and the like from the second cable 470 from being radiated to the outside.

This is because the electricity flowing in the second cable 470 may generate the electric field, the electromagnetic wave, and the like, and these may be radiated and have a negative effect on an electric device such as an adjacent board. To this end, in an embodiment, a shield member 610 may be disposed in the cable. First, a structure of the second cable 470 will be described.

The second cable 470 may include a plurality of wires. The plurality of wires may include at least one of the communication line 620, the electricity line 630, and a grounding line 640. In addition, the plurality of wires may include all of the communication line 620, the electricity line 630, and the grounding line 640.

The communication line 620 includes a pair of communication lines and is for communication of transmitting information. The electricity line 630 includes a pair of electricity lines and is for supplying electricity. The grounding line 640 is for grounding and is able to be equipped as a single wire.

The grounding line 640 may be disposed to improve an operating performance of each board by grounding the electricity leaked from each board. For example, the grounding line 640 may be electrically connected to a main board 420, and the main board 420 may be equipped with a grounding terminal for the grounding, so that the electricity leaked from each board may be grounded.

In an embodiment, the second cable 470 may include the shield member 610 that surrounds the plurality of wires and is made of a metal material.

In one example, the second cable 470 may include a surface layer that surrounds the shield member 610 and is made of an insulating material.

The shield member 610 may surround the communication line 620, the electricity line 630, and the grounding line 640, and may be formed as a thin film made of a metal material. Noise occurring from the electricity line 630 may be blocked from being radiated to the outside by the shield member 610.

That is, the electric field, the electromagnetic wave, and the like may be radiated to the outside from the electricity line 630, and the metallic shield member 610 may block or suppress the external radiation of the noise by blocking the electric field and the electromagnetic wave.

In an embodiment, the noise occurring from the electricity line 630 may be blocked from being radiated to the outside by shield member 610 surrounding the electricity line 630, and thus, the board adjacent to the first cable 450 and the second cable 470 may be free from the influence of the noise occurring from the electricity line 630, so that an operating performance of an electric device equipped in the cooking appliance may be improved.

In one example, when necessary, the third cable 510 may also include the shield member 610, the communication line 620, the electricity line, and the grounding line 640, similar to the second cable 470.

In one example, the above-described connecting cable 700 may also have a structure similar to that of the second cable 470 described above.

FIG. 23 is a diagram for illustrating a structure in which the second grounding terminal 742 is coupled to the front protruding portion 24.

The front protruding portion 24 may include a sub-coupling portion 3225b made of a metal material. In addition, the front protruding portion 24 may include a screw fastening boss 321e disposed at a location corresponding to the sub-coupling portion 3225b.

The sub-coupling portion 3225b may include a sub-bending portion 25b2 and a fastening hole defining portion 25b3. The sub-bending portion 25b2 may be bent when assembling the front protruding portion 24. To facilitate the bending, the sub-bending portion 25b2 may be generally formed to be thin and long and have a small thickness.

The fastening hole defining portion 25b3 may be disposed at a location corresponding to the screw fastening boss 321e when the sub-bending portion 25b2 is bent, and may have a screw fastening hole 25b1 defined therein. When the sub-bending portion 25b2 is bent for the coupling, the screw fastening hole 25b1 may be defined at a location corresponding to a hole of the screw fastening boss 321e.

In one example, a hole corresponding to the screw fastening hole 25bl may also be defined in the second grounding terminal 742. A grounding screw 1100, which is a coupling mechanism, may be disposed to couple the second grounding terminal 742 to the front protruding portion 24.

The grounding screw 1100 may be screw-fastened to the screw fastening boss 321e by extending through the hole of the second grounding terminal 742 and the screw fastening hole 25b1 of the sub-coupling portion 3225b. Accordingly, the second grounding terminal 742 may be fastened to the front protruding portion 24 and come into contact with the sub-coupling portion 3225b.

When the sub-coupling portion 3225b made of the metal material and the second grounding terminal 742 are coupled to each other, the metal component of the front protruding portion 24 may be electrically connected to the microcomputer 1000, and accordingly, the metal component of the front protruding portion 24 may be grounded.

In one example, the first grounding terminal 741 may also be coupled to a metal portion of the display 100 in a similar manner as described for the second grounding terminal 742 by the grounding screw 1100, and thus the display 110 may be grounded.

Although the present disclosure has been described with reference to the accompanying drawings, the present disclosure is not limited by the embodiments disclosed herein and the drawings, and it is obvious that various modifications may be made by those skilled in the art within the scope of the technical idea of the present disclosure. In addition, although the effects based on the configuration of the present disclosure are not explicitly described and illustrated in the description of the embodiment of the present disclosure above, it is natural that predictable effects of the corresponding configuration should also be recognized.

What is claimed is:

1. A cooking appliance comprising a main body with a cavity defined therein, and a door configured to open and close the cavity, wherein the door includes:
a plurality of boards;
a cable electrically connecting the plurality of boards to each other; and
a bead disposed on the cable.

2. The cooking appliance of claim 1, wherein the door includes:
a display disposed at a front portion of the door and configured to display an image thereon;
a display board electrically connected to the display and configured to control an operation of the display;
a control board electrically connected to the display board and including a controller configured to control the operation of the display;
a first cable electrically connecting the display board with the control board;
a first bead disposed on the first cable and including a ferrite material; and
a first communication board electrically connected to the control board and connecting the cooking appliance with another home appliance so as to enable communication therewith.

3. The cooking appliance of claim 2, wherein the door includes:
a second cable electrically connecting the control board with the first communication board; and
a second bead disposed on the second cable and including the ferrite material.

4. The cooking appliance of claim 3, wherein the door includes:
an antenna electrically connected to the control board and connecting at least one of a server and a terminal with the cooking appliance so as to enable communication therewith; and
a third cable electrically connecting the control board with the antenna.

5. The cooking appliance of claim 3, wherein the second cable includes a plurality of wires, and a shield member disposed to surround the plurality of wires and made of a metal material.

6. The cooking appliance of claim 5, wherein the plurality of wires include:
a communication line including a pair of communication lines and for communication of transmitting information;
an electricity line including a pair of electricity lines and for supplying electricity; and
a grounding line for grounding.

7. The cooking appliance of claim 3, wherein the first bead is constructed to eliminate or suppress electrical noise occurring in the first cable, and
wherein the second bead is constructed to eliminate or suppress electrical noise occurring in the second cable.

8. The cooking appliance of claim 3, wherein the door includes an outer panel disposed at the rear of the display and where the display is mounted, and
wherein the display board, the control board, the first communication board, and the antenna are mounted on the outer panel and are disposed in an internal space defined by coupling the display with the outer panel.

9. The cooking appliance of claim 8, wherein the outer panel includes:
a front plate coupled with the display;
a first mounting portion formed to protrude from the front plate, wherein the first bead is detachably mounted on the first mounting portion; and
a second mounting portion formed to protrude from the front plate and disposed to be spaced apart from the first mounting portion, wherein the second bead is detachably mounted on the second mounting portion.

10. The cooking appliance of claim 9, wherein the outer panel includes a plurality of mounting casings formed to protrude from the front plate, wherein the display board, the control board, the first communication board, and the antenna are mounted on the plurality of mounting casings.

11. A door of a cooking appliance, the door comprising:
a display board configured to control an operation of a display;
a control board electrically connected to the display board and including a controller configured to control the operation of the display;
a first cable electrically connecting the display board with the control board;
a first bead disposed on the first cable and including a ferrite material;
a first communication board electrically connected to the control board and connecting the cooking appliance with another home appliance so as to enable communication therewith;
a second cable electrically connecting the control board with the first communication board; and
a second bead disposed on the second cable and including the ferrite material.

12. The door of claim 11, further comprising:
an antenna electrically connected to the control board and connecting at least one of a server and a terminal with the cooking appliance so as to enable communication therewith; and
a third cable electrically connecting the control board with the antenna.

13. The door of claim 12, wherein the second cable includes a plurality of wires, and a shield member disposed to surround the plurality of wires and made of a metal material.

14. The door of claim 12, further comprising an outer panel disposed at the rear of the display and where the display is mounted,
wherein the display board, the control board, the first communication board, and the antenna are mounted on the outer panel and are disposed in an internal space defined by coupling the display with the outer panel.

15. The door of claim 14, wherein the outer panel includes:
a front plate coupled with the display;
a first mounting portion formed to protrude from the front plate, wherein the first bead is detachably mounted on the first mounting portion;
a second mounting portion formed to protrude from the front plate and disposed to be spaced apart from the first mounting portion, wherein the second bead is detachably mounted on the second mounting portion; and
a plurality of mounting casings formed to protrude from the front plate, wherein the display board, the control board, the first communication board, and the antenna are mounted on the plurality of mounting casings.
